(19) United States
(12) Patent Application Publication
(10) Pub. No.: US 2005/0171796 A1
(43) Pub. Date: Aug. 4, 2005

(54) Method and apparatus for building a hierarchical structure of representatives

(76) Inventor: Robert B. Goodrich, Ocean City, NJ (US)

Correspondence Address: RATNERPRESTIA, P O BOX 980, VALLEY FORGE, PA, 19482-0980, US

(21) Appl. No.: 10/770,208

(22) Filed: Feb. 2, 2004

(51) Int. Cl. G06F 17/60

(52) U.S. Cl. 705/1

(57) ABSTRACT

A hierarchical structure of representatives is built. A request for a new representative to be added as a new level to the hierarchical structure of representatives is received. The new representative is provided with a data structure corresponding to a portion of the hierarchical structure above the new level. Reports are received from the new level through the use of the data structure. Tabulation of results from the reports from the new representative is possible. Comparison of results from the reports from the new representative with the expected results are also possible.

### FIELD OF THE INVENTION

The present invention relates to entities organized in a hierarchical structure and more specifically to data transfer in such a structure. In particular, a method and apparatus are disclosed for building such a structure and collecting/disseminating data within such a structure.

### BACKGROUND OF THE INVENTION

Multilevel compensation plans are well-known in the art. An exemplary multilevel compensation plan is illustrated with reference to FIG. 12. The multilevel compensation plan is illustrated as a hierarchical structure (or tree structure) having multiple levels. At each level, each entity (individual, group, company, etc.) is represented as a respective node. The multilevel compensation plan illustrated in FIG. 12 begins at Level 1 where an entity (at the root node of the tree) initiates the forming of the multilevel compensation plan. To start, the entity at Level 1 (i.e. the “sponsor”) forms business relationships with the entities shown at Level 2 (i.e. the “representatives”). The entities at Level 2 perform sales transactions using sales methodology which has been provided to them by the entity at Level 1. Sales methodology may include, for example, customer lists, sales techniques, bill processing, payment processing, product distribution, service distribution, etc.

As the entities at Level 2 complete sales transactions, those entities make profit. That profit is then shared with the entity at Level 1 because the transactions were completed using the methodology from the entity at Level 1.

The entities at Level 2 may then become sponsors by establishing relationships with further entities (who then become new representatives). Those further entities are shown in FIG. 12 at Level 3. Again, as entities at Level 3 complete transactions, the entities at Level 2 and Level 1 receive a portion of the profits. The forming of relationships may continue for a lengthy period of time thus establishing many levels to the hierarchical structure shown in FIG. 12, with representatives becoming sponsors to new representatives, thus causing the hierarchical structure to grow. As more entities join the hierarchical structure and as the number of levels in the hierarchical structure increases, entities at older levels (i.e. closer to the top of the hierarchical structure) have the potential to receive portions of profits from increasing numbers of entities. This creates the possibility of making large profits.

One difficulty with a multilevel compensation plan as shown in FIG. 12 can be an inability to accurately track the economic results at each level.

### SUMMARY OF THE INVENTION

A hierarchical structure of representatives is built. A request for a new representative to be added as a new level to the hierarchical structure of representatives is received. The new representative is provided with a data structure corresponding to a portion of the hierarchical structure above the new level. Reports are received from the new level through the use of the data structure. Tabulation of results from the reports from the new representative is possible. Comparison of results from the new representative with expected results are also possible.

### BRIEF DESCRIPTION OF THE DRAWINGS

FIG. 1 is a flow chart diagram which illustrates how an individual becomes a representative in a hierarchical structure according to an exemplary embodiment of the present invention.

FIG. 2 is a flow chart diagram which illustrates how information pertaining to a representative is entered into a database according to an exemplary embodiment of the present invention.

FIG. 3 illustrates the main screen of a tracking system.

FIG. 4 is a flow chart diagram which illustrates how an exemplary embodiment of the present invention is made available for a new representative.

FIG. 5 is a flow chart diagram which illustrates how a new representative initiates operation of an exemplary embodiment of the present invention.

FIG. 6 is a flow chart diagram which illustrates how a representative may use an exemplary embodiment of the present invention.

FIG. 7 is a flow chart diagram which illustrates how a representative imports data received from sponsored representatives in accordance with an exemplary embodiment of the present invention.

FIGS. 8A-8G illustrate the data contained in data structures according to an exemplary embodiment of the present invention.

FIG. 8H illustrates the data of FIGS. 8A-8G in graph form.

FIG. 9 illustrates an input/edit screen according to an exemplary embodiment of the present invention.

FIG. 10 illustrates a progress report which is generated in accordance with an exemplary embodiment of the present invention.

FIG. 11 illustrates a downline report which is generated in accordance with an exemplary embodiment of the present invention.

FIG. 12 is a diagram which illustrates a hierarchical structure in accordance with the prior art.

### DETAILED DESCRIPTION OF THE INVENTION

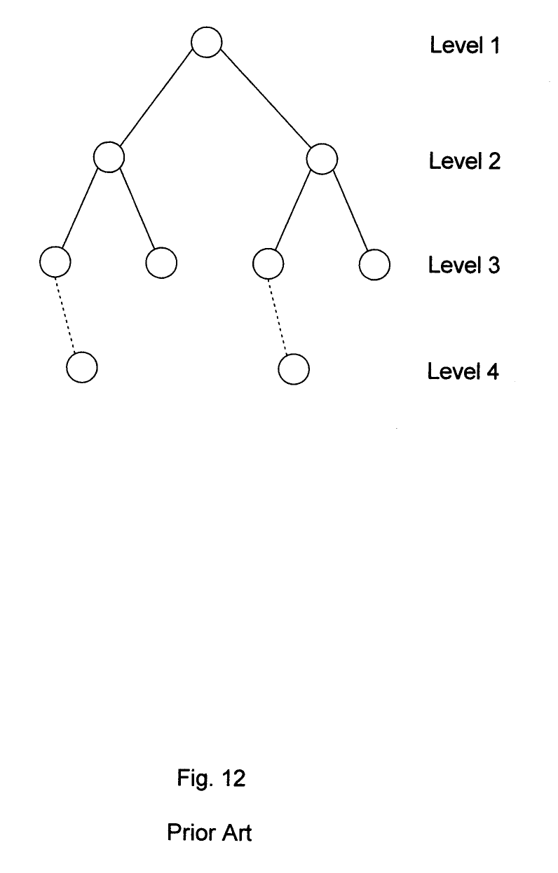

Returning again to the prior art shown in FIG. 12, it can be difficult to have a clear understanding of the economic conditions that are occurring at each level (and/or each node) within the hierarchical structure as well as how many additional nodes are actually being added by an entity in the downline (i.e. below the entity in the hierarchical structure). Without possessing this understanding, it is possible that certain entities within the hierarchical structure will become disappointed with their economic results. In other words, certain entities may not have a realistic understanding of the rate at which economic growth increases and specifically, the rate at which new entities are added to new levels. Thus, if their expectations are unrealistic and are not met, then those entities may leave the hierarchical structure before waiting an appropriate amount of time for economic success to be achieved. One cause of unrealistic expectations is a confusion which often occurs in the rate of growth of such hierarchical structures between linear terms and geometric terms. People (i.e. representatives) may think in linear terms. Thus, people may feel that after (for example) a 20% passage of time, people should be 20% (in dollars) of the way toward their financial goals. In multilevel compensation systems, however, growth is typically geometric rather than linear. Thus, an inability for entities to appreciate a geometric growth relationship between the amount of time they spend in the hierarchy and their income level may result in a premature resignation from the business, even though such entities are on the correct path to reach their financial goals.

A typical illustration of geometric growth is the phenomenon of starting with a penny and doubling the value every day for 30 days. As shown in Table 1, the result after 30 days is over $10,000,000. What is interesting, though, is the relationship between the passage of time and the amount of funds. For example, after 10 days (which is ⅓ of the total time) the total of $10.24 is a negligible percentage of the final amount of $10,000,000. Linear growth after 10 days would predict $3,500,000 instead of just a little over $10. After 20 days (which is ⅔ of the total time), the total of $10,486 is about 0.1% of the final amount. One percent of the final amount is not reached until day 24, which is 80% of the total time. Thus, it is seen that the economic growth in the above example is not linear. If an entity expects the above growth to be linear, that entity may quit after 20 days, being discouraged that only 0.1% of the final amount has been attained.

TABLE 1

| | | | | | | | % of Goal | % of Days |
|---|---|---|---|---|---|---|---|---|
| | Day | Dollars | Day | Dollars | Day | Dollars | Day 21-30 | Day 21-30 |
| Beginning Amount | 0 | 0.01 | | | | | | |
| | 1 | 0.02 | 11 | 20.48 | 21 | 20,972 | 0.20% | 70.00% |
| | 2 | 0.04 | 12 | 40.96 | 22 | 41,943 | 0.39% | 73.33% |
| | 3 | 0.08 | 13 | 81.92 | 23 | 83,886 | 0.78% | 76.67% |
| | 4 | 0.16 | 14 | 163.84 | 24 | 167,772 | 1.56% | 80.00% |
| | 5 | 0.32 | 15 | 327.68 | 25 | 335,544 | 3.13% | 83.33% |
| | 6 | 0.64 | 16 | 655.36 | 26 | 671,089 | 6.25% | 86.67% |
| | 7 | 1.28 | 17 | 1,310.72 | 27 | 1,342,177 | 12.50% | 90.00% |
| | 8 | 2.56 | 18 | 2,621.44 | 28 | 2,684,355 | 25.00% | 93.33% |
| | 9 | 5.12 | 19 | 5,242.88 | 29 | 5,368,709 | 50.00% | 96.67% |
| | 10 | 10.24 | 20 | 10,485.76 | 30 | 10,737,418 | 100.00% | 100.00% |
| Percentage of | 10 | 0.0001% | 20 | 0.0977% | 30 | 100.0000% | | |
| Goal | | | | | | | | |
| Elapsed Days (%) | 10 | 33.3333% | 20 | 66.6667% | 30 | 100.0000% | | |
| Linear to Goal | 10 | $3,579,139 | 20 | $7,158,279 | 30 | $10,737,418 | | |

In order to give entities in a hierarchical structure a better sense of their economic growth (and potential), a method and apparatus are disclosed for building the hierarchical structure and providing reporting of economic achievement at each level. In addition, the ability to compare actual growth with expected growth is provided.

Thus, in an exemplary embodiment of the present invention, an entity wants to become a new representative in a hierarchical structure of representatives. Thus, the entity wants to be added as a new level (or at an existing level) to the hierarchical structure of representatives. In accordance with an exemplary embodiment of the present invention, this is accomplished so that economic reports can be distributed from the new representative upwards through the hierarchical structure. Thus, as the reports are transmitted upwards, entities at each level can use the information contained in the reports to objectively measure their respective current economic success.

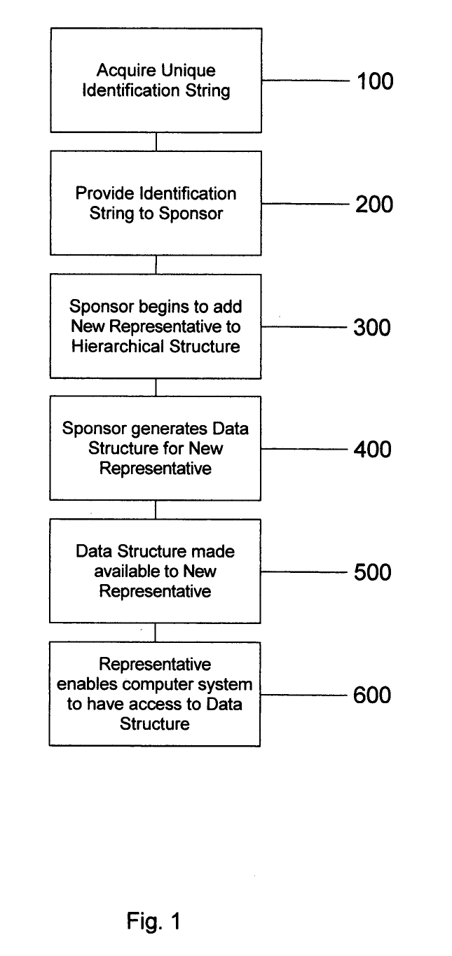

The manner in which a new representative is added to the hierarchical structure is illustrated with the flow chart diagram shown in FIG. 1. The new representative can be added at an existing level of the hierarchical structure or at a newly added level to the hierarchical structure. Also, a further representative (who is one level above the new representative in the hierarchical structure) is responsible for sponsoring the new representative. The further representative is situated a level above the new representative and is considered the new representative's sponsor. The relationship between a representative and the representative's sponsor on a graph (the graph of FIG. 12, for example) is denoted by a branch between the respective nodes representing the representative and the sponsor.

At step 100, a new representative to be added to the hierarchical structure acquires a unique identification string. This identification string is used to uniquely identify the new representative. The identification string can be supplied by the new representative himself. In that case, it can be a social security number, a name, a string produced by a random number generator, or some other form of unique string generation as would be understood to one of ordinary skill in the art. Alternatively, the string can be supplied by another entity in the hierarchical structure (e.g. from the root node or another node). In a further alternative, the identification string can be produced by a third party outside of the hierarchical structure.

At step 200, if the sponsor does not have the identification string, then the identification string is provided to the sponsor. At step 300, the sponsor begins the process of adding the new representative to the hierarchical structure. At step 400, the sponsor generates a data structure for the new representative. At step 500, the data structure is made available to the new representative. At step 600, the new representative enables his computer system to have access to the data structure.

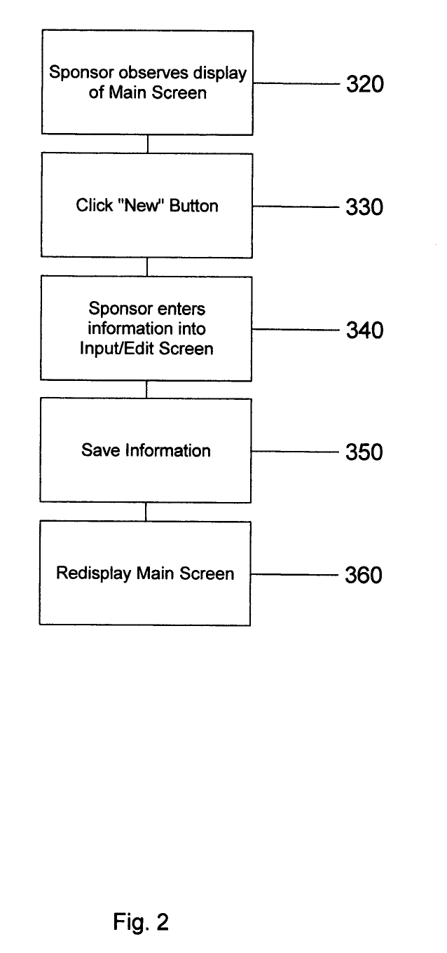

Referring to FIG. 2, FIG. 2 illustrates how step 300 of FIG. 1 is performed. Thus, at step 320, the sponsor will observe the display of the main screen.

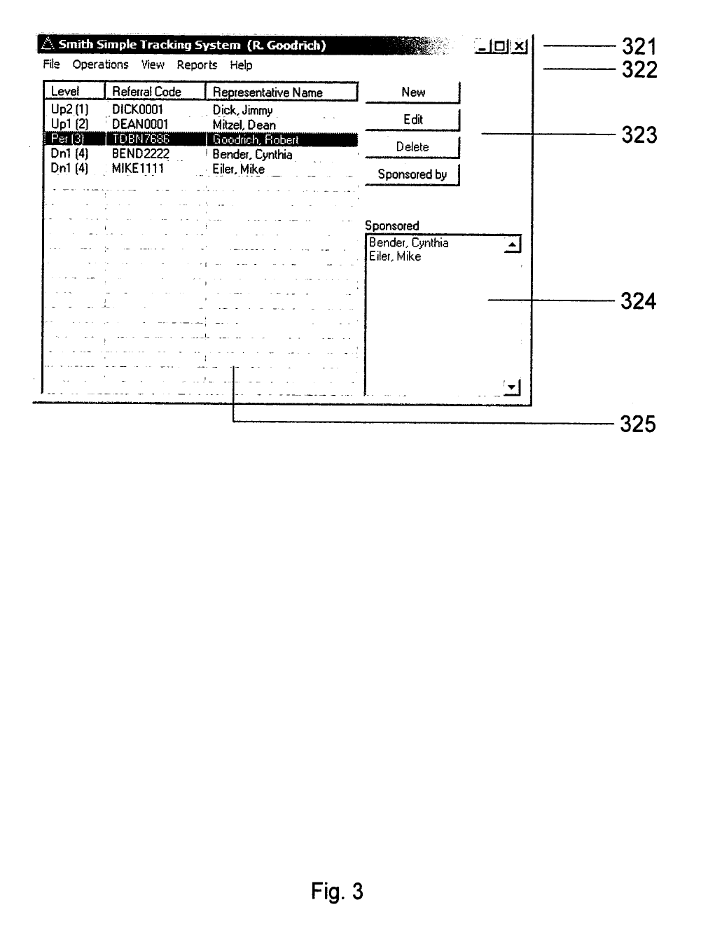

FIG. 3 shows the major parts of the main screen. The main parts are the title bar 321, the menu bar 322, the button group 323, the sponsor list 324, and the representative listing 325. The title bar 321 displays the name of the representative for which corresponding data is displayed. The menu bar 322 provides various drop down menus. The button group 323 displays various clickable buttons (e.g. New, Edit, Delete, Sponsored By). The sponsor list 324 displays representatives who are a level below a representative who is highlighted in representative listing 325. The first column of the representative listing 325 contains the organization level. The organization level is labeled in relation to the representative using the system. The representative using the system is indicated as being on the personal level which is labeled “PER” in the representative listing. All levels higher in the hierarchical structure are labeled “UP” and all levels lower in the hierarchical structure are labeled “DN”. Levels are also labeled in relation to their respective level number in the overall hierarchical structure. A unique identification string for the representative (sometimes referred to as a referral code) is displayed in a second column. The representative name may appear in a third column.

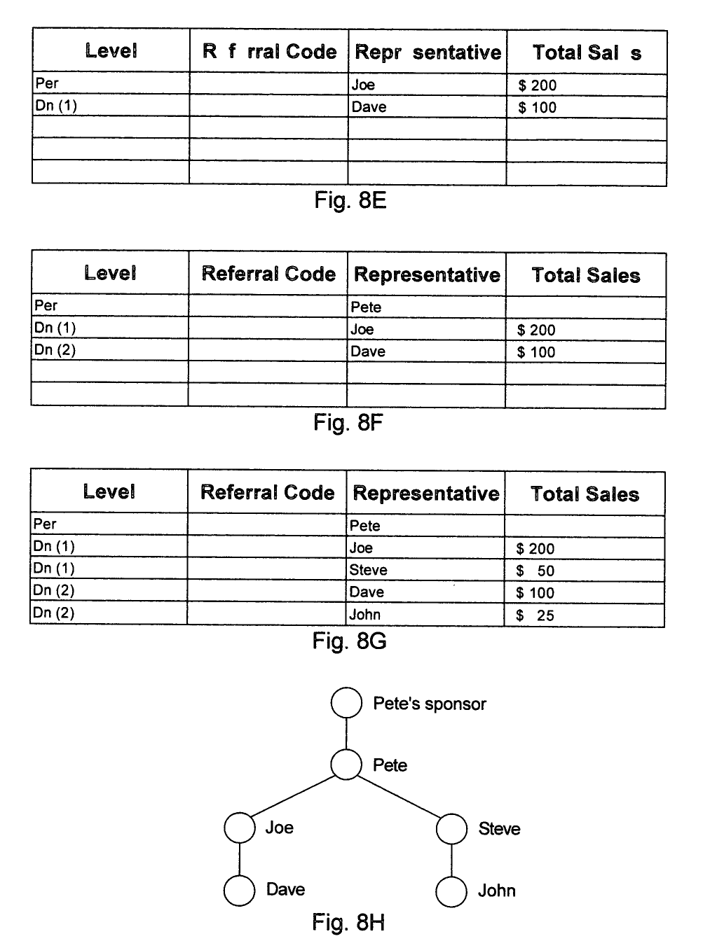

Returning to FIG. 2, at step 330, the sponsor continues the process of adding a new representative to the hierarchical structure by clicking the “New” button on the main screen to select the “Input/Edit Representative Information” screen. An exemplary “Input/Edit Representative Information” screen is illustrated in FIG. 9. Then, at step 340 of FIG. 2, the sponsor enters information into that screen. At step 350, to save the information to the database, the sponsor clicks the OK button thus adding a new record to the database. Again, in FIG. 9, the “Referral Code” is the unique identification string of the new representative.

After the new record has been saved, the main screen is redisplayed at step 360. Now, however, the list of representatives displayed on the main screen includes the name and the unique identification string of the new representative.

Returning to FIG. 1, at step 400, the sponsor makes a data structure available for use by the new representative so that the new representative can participate in adding entities and new levels to the hierarchical structure.

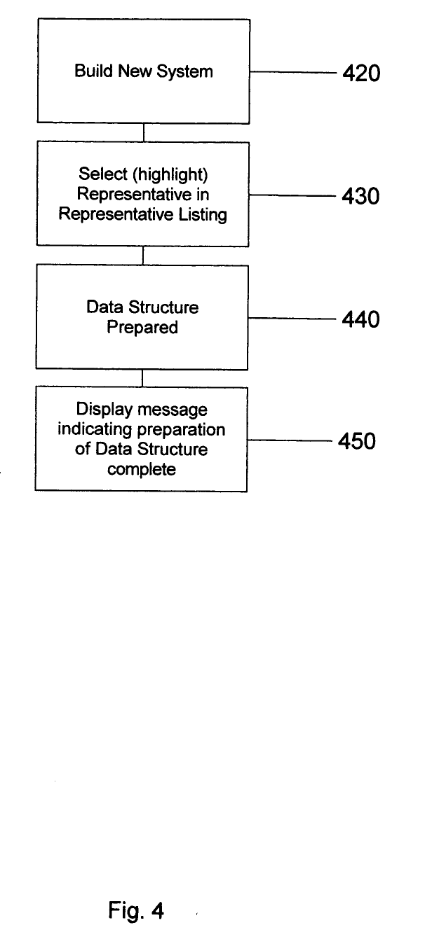

The process of making the data structure available is illustrated with reference to FIG. 4. At step 420, from the Main Screen, the sponsor displays the “Operations Menu” and then clicks “Build New System” to prepare the data structure. At step 430, the sponsor selects the name of the new representative from a representative listing on the screen (not shown). At step 440, the data structure is prepared. This data structure is derived from the sponsor's database. The following, however, should be noted:

(1) the selected new representative is designated as being on the personal “PER” level;

(2) the levels of upline representatives are the same as in the sponsor system (as indicated by the sponsor's data structure) except that the sponsor is shown as the first level “UP” above the “PER” level of the new representative;

(3) there are no downline representatives “DN”.

At step 450, a message is displayed indicating that the preparation of the new data structure has been completed. A data file which includes the new data structure is written with a unique file name.

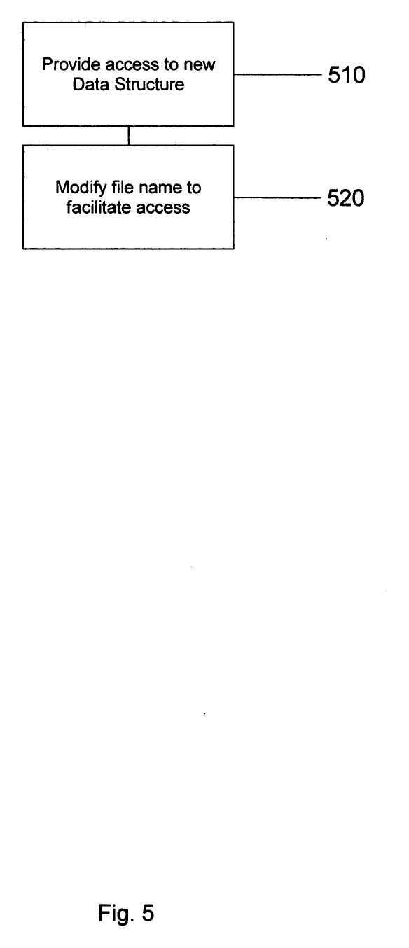

Returning to FIG. 1, at step 500, the newly constructed data structure is made available to the new representative. This is illustrated by FIG. 5. At step 510, access to the new data structure is provided to the new representative. This may include granting permission, copying files, or both. Also, if needed, software may be made available to the new representative to access the data structure. At step 520, the file name containing the data structure may be modified, if needed, to facilitate access to the data structure by the new representative.

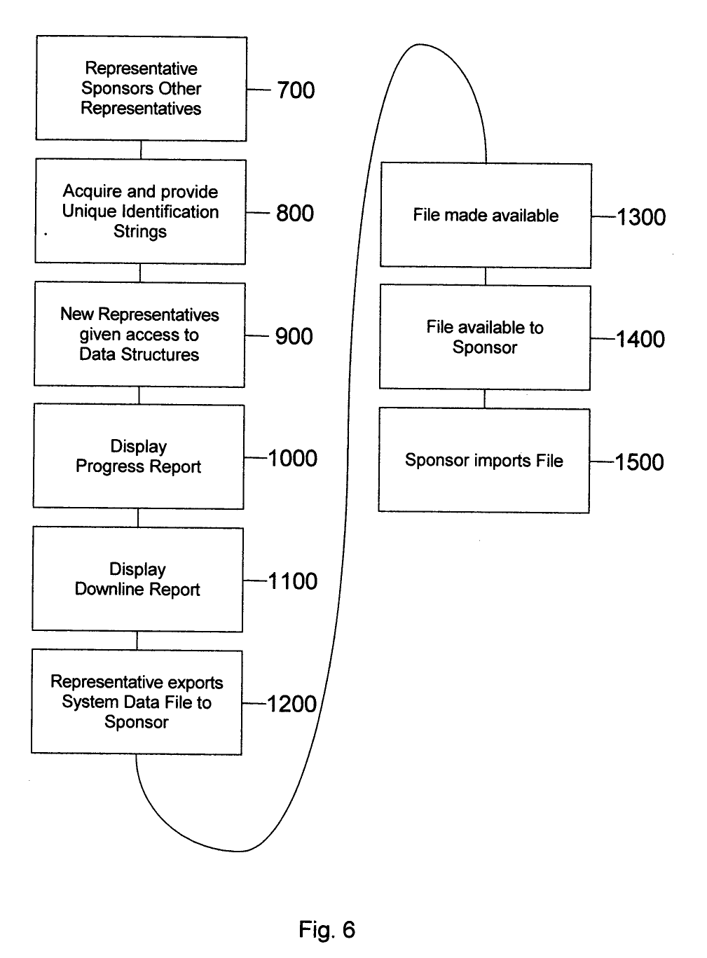

Once the data structure is available for use by the new representative (along with appropriate software to manipulate the data structure or copy thereof), the new representative can share information with his sponsor (or others above the new representative in the hierarchical structure). The new representative can also assume the role of sponsor and allow other new representatives to join the hierarchical structure. Such use is illustrated by the flow chart diagram of FIG. 6. As shown in step 700, the representative, which is now part of the hierarchical structure, is now able to receive requests from other entities to become new representatives at a new level of the hierarchical structure. Thus, a plurality of steps is are performed which are similar to steps previously performed when the new sponsor, himself, became a new representative at a new hierarchical level. The steps are summarized here to facilitate understanding. At step 800, each of the new representatives acquires respective unique identification strings and provides these unique strings to the sponsor who himself was the new representative of FIG. 2.

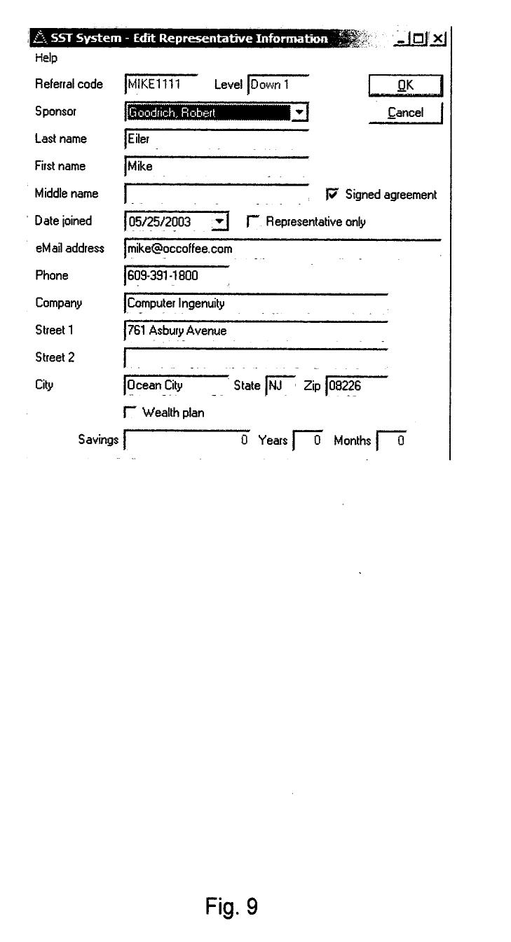

Each new representative is then given data structure (and software, if needed) access (step 900). At step 1000, the new representative is able to display a Progress Report. This is more clearly explained with reference to FIG. 10 (discussed below).

The above explanation has been of an exemplary embodiment of the present invention with regard to the generation and availability of data structures. More specifically, the various entities are able to share data within the hierarchical structure because access to an appropriate data structure has been given to them. Now that an explanation has been given regarding the initial access to that data structure, an explanation will now be provided as to how that data structure is used to share information.

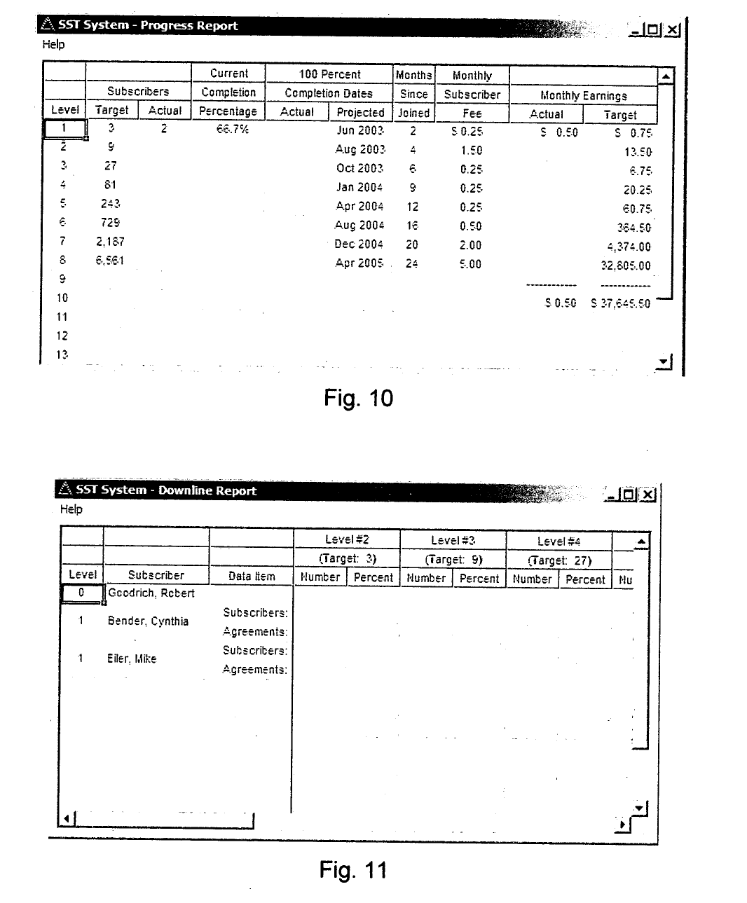

At step 1100, an entity within the hierarchical structure is able to display a downline report. Assuming that the entity displaying the downline report is a sponsor, the sponsor appears in the downline report at Level 0. This level is designated as Level 0 relative to this representative (and not necessarily relative to the entire hierarchical structure). Representatives one level below the sponsor are indicated as being at level one. Initially, before the sponsor's representatives have begun to make sales and to report the results of their sales, an exemplary downline report may appear as shown in FIG. 11. This report may provide (or exclude) various types of data, depending upon what is desired. For example, the report may be used to indicate total number of entities in the hierarchical structure at various levels. Alternatively, this report can be used to provide sales information (e.g. dollar amounts, sales volume, etc.) at various levels for those entities. As shown, this report does not show any results from entities below the sponsor because results have not been provided from those entities at this time to the sponsor. All that is shown at this stage is the names of representatives which have joined the hierarchical structure as a result of the sponsor (shown at Level 0) making the data structure available. As will be discussed later, as an entity receives results from his sponsored representatives, the downline report will contain additional information.

Next, an explanation will be provided for sharing data from one level of the hierarchical structure to a higher level of the hierarchical structure (i.e. from representatives to their sponsor).

Using the data structure which as been made accessible by the sponsor, the representative uses the data structure to store data in a file which will be referred to as the System Data File. At step 1200, a representative is able to export the contents of his System Data File to his sponsor. Thus, at step 1200, the representative creates this file with a file name which contains the unique ID (identification string) of the representative. At step 1300, the file is actually transmitted (or made available) to the representative's sponsor. The file can be transmitted by any means including, but limited to, e-mail, CD-ROM, or other media.

At step 1400, the sponsor receives the file which has been transmitted from the representative. Then, at step 1500, the sponsor imports the contents of the representative's System Data File into the sponsor's computer system.

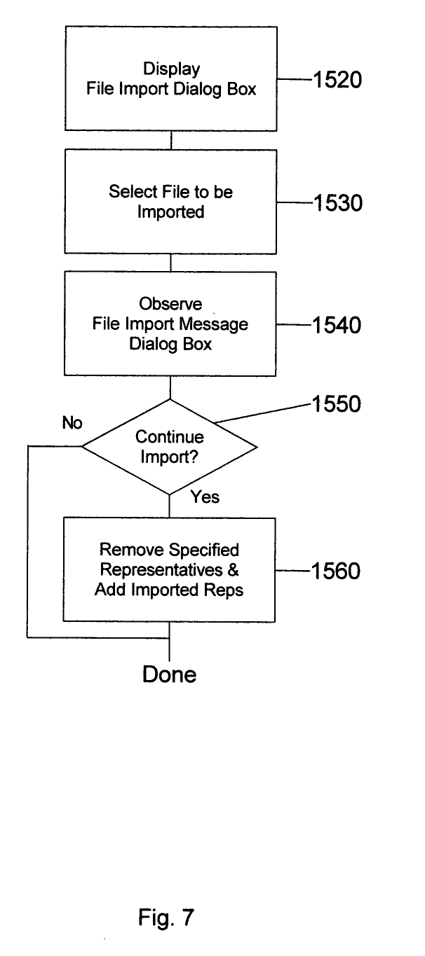

The process of importing the contents of the System Data File into the sponsor's computer system is shown in FIG. 7. At step 1520, the sponsor displays a dialog box on his computer system which is used for initiating the import of data into the sponsor's System Data File. At step 1530, the sponsor selects the file to be imported into the sponsor's computer system. At step 1540, particulars relevant to the data to be imported are displayed. Exemplary information includes:

(1) the identification string and the name of the representative which correspond to the entity which provided the data (the representative will be on the personal level in the file);

(2) the levels in the sponsor's computer system which will be modified by the import process;

(3) the number and levels of representatives which are new to the computer system of the sponsor;

(4) a question as to whether the sponsor wishes to continue with the import process.

If the sponsor says “Yes”, then processing will continue from step 1550 to step 1560. If the sponsor says “No”, the import process will terminate.

Returning to step 1560, if the sponsor has said “Yes” to the import process, then actual importing of the data from the system data file provided by the representative will commence. In the sponsor's computer system, the sponsor acquires the appropriate data provided to him by the representative. Thus, the data which appeared at the personal level in the representative's computer system will appear down one level in the sponsor's computer system. Similarly, data which appeared down one level in the representative's computer system will appear down two levels in the sponsor's computer system.

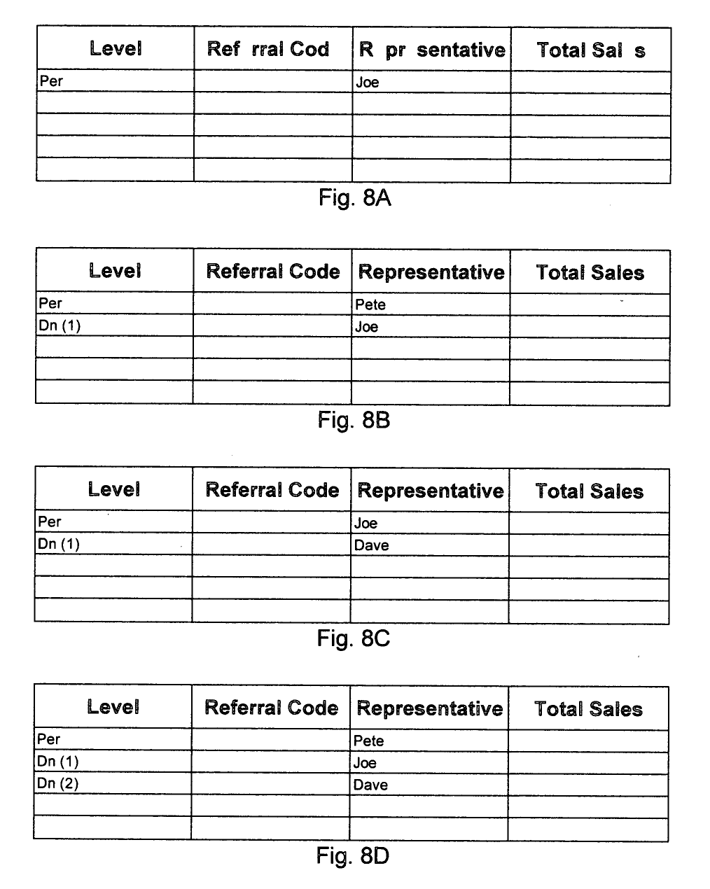

The manner in which information is transferred between different levels of the hierarchical structure is illustrated with reference to the drawings shown in FIGS. 8A-8G. FIG. 8H is a graph which illustrates the relationship between the entities described with reference to FIGS. 8A-8G. In FIG. 8A, a representative (let's call him “Joe”) has his name in the data structure. In FIG. 8B, Joe provides a copy of his system data to his sponsor (let's call him “Pete”). Thus, in FIG. 8B, Pete completes the import of Joe's system data. Pete appears in Pete's computer system at the personal level and Joe appears down one level. In FIG. 8C, Joe himself has become a sponsor and is sponsoring a new representative (let's call him “Dave”). Dave is shown in Joe's computer system at down one level. When Joe then again exports his data to Pete, Pete's data system will show Pete at the personal level, Joe down one level and Dave down two levels (see FIG. 8D). In FIG. 8E, Dave has completed the step of exporting his sales data (step not shown) to Joe. Thus, in the step shown in FIG. 8E, Dave has exported data indicating $100 worth of sales. Furthermore, Joe has entered into Joe's computer system that Joe himself has made $200 worth of sales. Next, at FIG. 8F, looking at Pete's computer system, after Joe has exported his data to Pete, it can be seen in Pete's computer system that Joe (down one level in Pete's computer system) has accomplished $200 worth of sales, and that Dave at down two levels has accomplished $100 worth of sales. Now Pete can export all this data to Pete's sponsor. In the sponsor's computer system, the sponsor would appear at the personal level, Pete would appear down one level, Joe would appear down two levels, etc.

FIG. 10 illustrates the progress report described in FIG. 6, step 1000. In this progress report, the total number of sales at each level are shown. Also, the total number of representatives sponsored by the sponsor at each level are shown. Referring to FIG. 8G, assume that Pete has sponsored Joe and Steve. Also Steve has sponsored John. Thus, in FIG. 8G, Pete is again shown at the personal level, Joe and Steve are shown down one level, and Dave and John are shown at down two levels. As each entity provides their data to the entity above, the entity above is able to display the data received from below. Thus, in FIG. 8G, Pete is able to see all of the sales results from one level down and two levels down.

As shown in FIG. 10, it is possible to combine the information into a meaningful report. In the progress report shown in FIG. 10, a target number of representatives at each level is listed. Based on the received information, it is possible to display in this table how close the goals at each level are to being achieved. Thus, returning again to FIG. 8G, two representatives exist at Level 1 and two representatives exist at Level 2. Total sales at Level 1 are $250. Total sales at Level 2 are $125.

The total sales can be shown at each level along with target sales at each level. In addition, each representative can maintain data indicating the date that they joined the hierarchical structure. With this data, it is possible to keep track of how long each entity has been in the hierarchical structure. This is useful for understanding the progress one is making towards meeting their financial goals, particularly in view of the fact that such progress typically follows geometric (versus linear) growth.

The above embodiment has been described with reference to sales. It is understood, however, that the invention is not limited to sales. For example, the invention can be used to acquire information from data gathering devices such as polls or questionnaires. One of ordinary skill in the art will recognize that the invention can be used for a variety of data acquisition purposes.

Although the invention is illustrated and described herein with reference to specific embodiments, the invention is not intended to be limited to the details shown. Rather, various modifications may be made in the details within the scope and range of equivalents of the claims and without departing from the invention.

1. A method of building a hierarchical structure of representatives, comprising:
(a) receiving a request for a new representative to be added as a new level to said hierarchical structure of representatives;
(b) providing said new representative with a data structure corresponding to a portion of said hierarchical structure above said new level;
(c) receiving reports from said new representative through the use of said data structure; and
(d) enabling at least one of
i) tabulation of results from said reports from said new representative;
and ii) comparison of results from said reports from said new representative with expected results.

2. A method of building a hierarchical structure of representatives according to claim 1 wherein step (a) includes the step of receiving an identification string for said new representative.

3. A method of building a hierarchical structure of representatives according to claim 1, wherein said request is accompanied by an identification string for said new representative.

4. A method of building a hierarchical structure of representatives according to claim 1, wherein said data structure indicates a path from said new representative upwards through a plurality of levels of said hierarchical structure.

5. A method of building a hierarchical structure of representatives according to claim 1, wherein said new representative is one of a plurality of new representatives at said new level, each of said new representatives are provided with respective data structures, reports are received from said new representatives, said reports are integrated to provide integrated information, and integrated forms of said results are compared with expected results.

6. A method of building a hierarchical structure of representatives according to claim 1, wherein said reports indicate sales results.

7. A method of building a hierarchical structure of representatives according to claim 6, wherein representatives receive income from further representatives below said representatives in said hierarchical structure.

8. A method of building a hierarchical structure of representatives according to claim 1, wherein said request for said new representative originates from said new representative.

9. A method of building a hierarchical structure of representatives according to claim 1, wherein an identification string is associated with said new representative and said new representative is identified in said reports by using said identification string.

10. A method of building a hierarchical structure according to claim 1, wherein said new level becomes part of said hierarchical structure of representatives and steps (a)-(d) are repeated.

11. A method of building a hierarchical structure of representatives, comprising:
(a) providing a request for a new representative to be added as a new level to said hierarchical structure of representatives;
(b) receiving a data structure corresponding to a portion of said hierarchical structure above said new level;
(c) providing reports from said new level to above said new level in said hierarchical structure based on said data structure.

12. A method of building a hierarchical structure of representatives according to claim 11, further comprising the step of
receiving said reports at above said new level in said hierarchical structure; and at least one of:
i) comparing results contained in said reports from said new representative with expected results; and
ii) tabulating results from reports from said new representative.

13. A method of building a hierarchical structure of representatives according to claim 11, wherein step (a) includes the step of requesting an identification string for said new representative.

14. A method of building a hierarchical structure of representatives according to claim 11, wherein said request is accompanied by an identification string for said new representative.

15. A method of building a hierarchical structure of representatives according to claim 11, wherein said data structure includes a path from said new representative upwards through a plurality of levels of said hierarchical structure.

16. A method of building a hierarchical structure of representatives according to claim 11, wherein said new representative is one of a plurality of new representatives at said new level, each of said new representatives are provided with respective data structures, reports are received from said new representatives, said reports are integrated to provide integrated information, integrated forms of said results are compared with expected results.

17. A method of building a hierarchical structure of representatives according to claim 11, wherein said reports indicate sales results.

18. A method of building a hierarchical structure of representatives according to claim 11, wherein representatives receive income from further representatives below said representatives in said hierarchical structure.

19. A method of building a hierarchical structure of representatives according to claim 11, wherein said request for said new representative originates from said representative.

20. A method of building a hierarchical structure of representatives according to claim 11, wherein an identification string is associated with said new representative and said new representative is identified in said reports by using said identification string.

21. A method of building a hierarchical structure according to claim 11, wherein said new level becomes a part of said hierarchical structure of representatives and steps (a)-(c) are repeated.

22. Apparatus for building a hierarchical structure of representatives, comprising:
a data structure generator for defining a data structure for a new level to a hierarchical structure;
an integrator for combining results from said new level provided by multiple representatives at said new level based on said data structure;
an output unit for at least one of
i)allowing comparison of said results after being combined with expected results; and
ii) tabulating said results after being combined.

23. A program storage device readable by machine, tangibly embodying a program of instructions executable by the machine to perform method steps for
(a) receiving a request for a new representative to be added as a new level to a hierarchical structure of representatives;
(b) providing said new representative with a data structure corresponding to a portion of said hierarchical structure above said new level;
(c) receiving reports from said new level through the use of said data structure; and
(d) enabling at least one of
i) tabulation of results from said reports from said new representative;
and ii) comparison of results from said reports from said new representative with expected results.
